(19) United States
(12) Patent Application Publication
(10) Pub. No.: US 2009/0135156 A1
(43) Pub. Date: May 28, 2009

(54) TOUCH SENSOR FOR A DISPLAY SCREEN OF AN ELECTRONIC DEVICE

(76) Inventors: ROBERT LOWLES, WATERLOO (CA); ZHONGMING MA, WATERLOO (CA); EDWARD HUI, WATERLOO (CA)

Correspondence Address: RESEARCH IN MOTION;ATTN: GLENDA WOLFE, BUILDING 6, BRAZOS EAST, SUITE 100, 5000 RIVERSIDE DRIVE, IRVING, TX, 75039, US

(21) Appl. No.: 11/944,482

(22) Filed: Nov. 23, 2007

(51) Int. Cl. G06F 3/045

(52) U.S. Cl. 345/174

(57) ABSTRACT

A touch sensor for mounting over a display screen of an electronic device is provided. The touch sensor includes: an elongate input pad formed in a layer of transparent conductive material on a transparent substrate, the input pad tapering from a broad end to a narrow end to provide an input pad capacitance that varies with location of a touch over the input pad; and, a contact for coupling the input pad to a processor.

### FIELD OF THE APPLICATION

This application relates to the field of touch sensors for electronic devices, and more specifically, to touch sensors for display screens of handheld, wireless, and other electronic devices.

### BACKGROUND

Handheld electronic devices may have a number of different configurations. Examples of such devices include personal data assistants (“PDAs”), handheld computers, two-way pagers, cellular telephones, and the like. Many handheld electronic devices also feature wireless communication capability, although many other handheld electronic devices are stand-alone devices that are functional without communication with other devices.

Such handheld electronic devices are generally intended to be portable, and thus are of a relatively compact configuration in which keys and other input structures often perform multiple functions under certain circumstances or may otherwise have multiple aspects or features assigned thereto.

In addition to using keys on a keypad, handheld electronic devices may also use a touchscreen. A touchscreen is a display screen overlay which provides the ability to display and receive information on the same display screen. The effect of the overlay is to allow a display screen to be used as an input device, possibly removing the keys on the keypad as the primary input device for interacting with the display screen's content. Display screens with integrated touchscreens can make computers and handheld electronic devices more useable. A touchscreen or touchscreen system typically includes a touch sensor, a controller or processor, and accompanying software. The controller communicates user selections to the processor of the electronic device in which the touchscreen is used.

One problem with existing LCD touchscreen displays relates to the arrangement of their touch sensors. In existing LCD touchscreen displays, in order to provide a number of input pads in an X/Y matrix arrangement, the touch sensor typically consists of two stacked indium tin oxide (“ITO”) polyethylene terephthalate (“PET”) polyester film layers. The first ITO PET film layer may include a number of rows of input pads (X inputs), the input pads in each row being connected in series. The second ITO PET film layer may include a number of columns of input pads (Y inputs), the input pads in each column being connected in series. However, this arrangement has several problems as follows.

First, the use of two ITO PET film layers increases the overall material and production costs of the touch sensor. In addition, the two stacked ITO PET film layers reduce the light transitivity and optical performance of the LCD touchscreen display.

Second, for on-screen keypad applications, it is difficult to distinguish between two adjacent icons. To achieve higher resolution, the X/Y matrix has to be expanded by adding additional rows and/or columns of input pads. However, the addition of more rows and/or columns means that additional input channels are required for the controller (i.e., each row or column requiring a separate input channel), which in some cases, is not possible. Additional traces for the additional row and column input channels translates into a requirement for additional routing space around the perimeter of the display which in turn results in a larger display. However, in many applications, larger displays cannot be accommodated.

Third, the use of additional input channels requires increased scanning times for the input pads and hence increased response times. In applications involving haptic feedback or gesture-based input, for example, increased response times are often not acceptable.

Fourth, it can be difficult to align icons presented on the display with the appropriate input pads of the X/Y matrix. As such, finger shadow effects may lead to the selection of wrong inputs.

Fifth, the increased density of controller input channel traces required for a higher resolution X/Y matrix effectively limits the size of the display that can be used. For example, a 1.8″ display may be implemented at high resolution but a 3.5″ display may not be practical as the increased density of the required controller input channel traces may simply take up too much space.

A need therefore exists for an improved touch sensor for a display screen of a handheld, wireless, or other electronic device. Accordingly, a solution that addresses, at least in part, the above and other shortcomings is desired.

### BRIEF DESCRIPTION OF THE DRAWINGS

Features and advantages of the embodiments of the present application will become apparent from the following detailed description, taken in combination with the appended drawings, in which:

FIG. 1 is a front view illustrating a handheld electronic device in accordance with an embodiment of the application;

FIG. 2 is a block diagram illustrating a processing system for the device of FIG. 1;

FIG. 3 is a top view illustrating a touch sensor and transparent cover for the device of FIG. 1;

FIG. 4 is a screen capture illustrating a keypad presented on the display screen of FIG. 1;

FIG. 5 is a screen capture illustrating a multimedia controller presented on the display screen of FIG. 1;

FIG. 6 is a top view illustrating an alternate touch sensor for the device of FIG. 1; and,

FIG. 7 is a top view illustrating a portion of an alternate touch sensor for the device of FIG. 1.

It will be noted that throughout the appended drawings, like features are identified by like reference numerals.

### DETAILED DESCRIPTION OF THE EMBODIMENTS

In the following description, details are set forth to provide an understanding of the application. In some instances, certain software, circuits, structures and techniques have not been described or shown in detail in order not to obscure the application. Embodiments of the present application may be implemented in any computer programming language provided that the operating system of the data processing system provides the facilities that may support the requirements of the application. Any limitations presented would be a result of a particular type of operating system or computer programming language and would not be a limitation of the present application.

According to one embodiment, there is provided a touch sensor for mounting over a display screen of an electronic device, comprising: an elongate input pad formed in a layer of transparent conductive material on a transparent substrate, the input pad tapering from a broad end to a narrow end to provide an input pad capacitance that varies with location of a touch over the input pad; and, a contact for coupling the input pad to a processor.

According to another embodiment, there is provided a touch sensor keypad for mounting over a display screen of an electronic device, comprising: at least one elongate input pad formed in a layer of transparent conductive material on a transparent substrate, the input pad tapering from a broad end to a narrow end to provide a respective input pad capacitance for each of a plurality of locations of a touch over the input pad; and, a contact for coupling the input pad to a processor; wherein the input pad forms a column or row of the keypad; and, wherein each of the plurality of locations of the touch corresponds to a respective key in the column or row of the keypad; whereby the input pad provides multi-touch functionality for the column or row of the keypad.

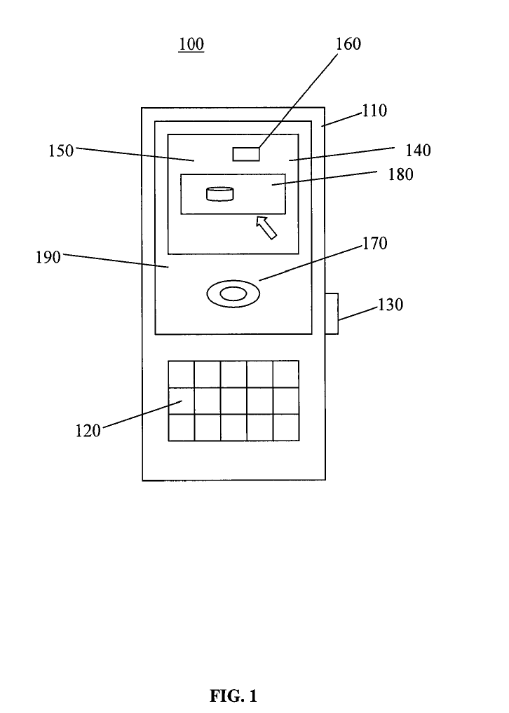

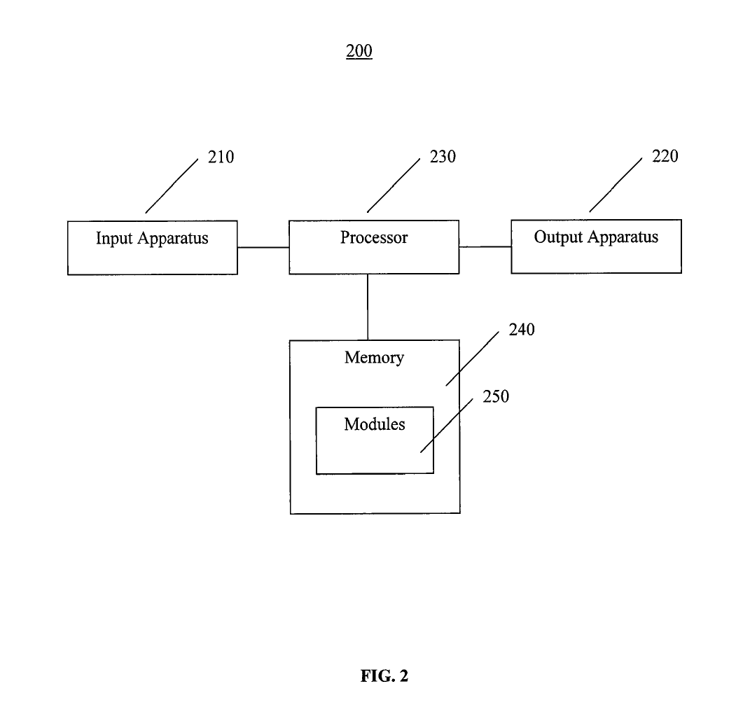

FIG. 1 is a front view illustrating a handheld electronic device 100 in accordance with an embodiment of the application. And, FIG. 2 is a block diagram illustrating a processing system 200 for the device 100 of FIG. 1. The exemplary handheld electronic device 100 includes a housing 110 in which is disposed a processing system 200 that includes an input apparatus 210, an output apparatus 220, a processor (or controller) 230, memory 240, and one or more hardware and/or software modules 250. The processor 230 may be, for example and without limitation, a microprocessor and is responsive to inputs from the input apparatus 210 and provides output signals to the output apparatus 220. The processor 230 also interfaces with the memory 240.

The handheld electronic device 100 may be a two-way communication device having voice and/or advanced data communication capabilities, including the capability to communicate with other computer systems. Depending on the functionality provided by the device 100, it may be referred to as a data messaging device, a two-way pager, a cellular telephone with data messaging capabilities, a wireless Internet appliance, a data communication device (with or without telephony capabilities), a wireless fidelity (“Wi-Fi”) device, a wireless local area network (“WLAN”) device, a wireless device, a handheld device, or a wireless handheld device.

According to one embodiment, the input apparatus 210 may include a keypad 120, a thumbwheel 130 or other input device such as a trackball, various buttons, etc., and a touchscreen 140. In addition to the keypad 120, the thumbwheel 130 can serve as another input member since the thumbwheel 130 is capable of being rotated and depressed generally toward the housing 110. Rotation of the thumbwheel 130 provides selection inputs to the processor 230, while depression of the thumbwheel 130 provides another selection input to the processor 230.

The output apparatus 220 includes a display screen 150 (e.g., a liquid crystal display (“LCD”)) upon which can be provided an output 180 such as a graphical user interface (“GUI”), a speaker 170, etc. An exemplary GUI 180 is shown on the display screen 150 in FIG. 1. The display screen 150 has associated circuitry and a controller or processor (e.g., 230, 240, 250) for receiving information from the processor of the handheld electronic device 100 for presentation.

The processor 230 is coupled to the input apparatus 210, output apparatus 220, and memory 240 for receiving user commands or queries and for displaying the results of these commands or queries to the user on the display screen 150. To provide a user-friendly environment to control the operation of the device 100, operating system (“O/S”) software modules 250 resident on the device 100 provide a basic set of operations for supporting various applications typically operable through the GUI 180 and supporting GUI software modules 250. For example, the O/S provides basic input/output system features to obtain input from the keypad 120, the thumbwheel 130, and the like, and for facilitating output to the user through the display screen 150, the speaker 170, etc. Though not shown, one or more applications for managing communications or for providing personal digital assistant like functions may also be included. According to one embodiment, the device 100 is provided with hardware and/or software modules 250 for facilitating and implementing various additional functions.

A user may interact with the device 100 and its various software modules 250 using the GUI 180. GUIs are supported by common operating systems and provide a display format which enables a user to choose commands, execute application programs, manage computer files, and perform other functions by selecting pictorial representations known as icons, or items from a menu through use of an input or pointing device such as a thumbwheel 130 and keypad 120. In general, a GUI is used to convey information to and receive commands from users and generally includes a variety of GUI objects or controls, including icons, toolbars, drop-down menus, pop-up menus, text, dialog boxes, buttons, and the like.

A user typically interacts with a GUI 180 presented on a display screen 150 by using an input or pointing device (e.g., a thumbwheel 130, a keypad 120, etc.) to position a pointer or cursor over an object (i.e., “pointing” at the object) and by “clicking” on the object (e.g., by depressing the thumbwheel 130, by depressing a button on the keypad 120, etc.). This is often referred to as a point-and-click operation or a selection operation. Typically, the object may be hi-lighted (e.g., shaded) when it is pointed at.

Typically, a GUI based system presents application, system status, and other information to the user in “windows” appearing on the display screen 150. A window is a more or less rectangular area within the display screen 150 in which a user may view an application or a document. Such a window may be open, closed, displayed full screen, reduced to an icon, increased or reduced in size, or moved to different areas of the display screen 150. Multiple windows may be displayed simultaneously, such as: windows included within other windows, windows overlapping other windows, or windows tiled within the display area.

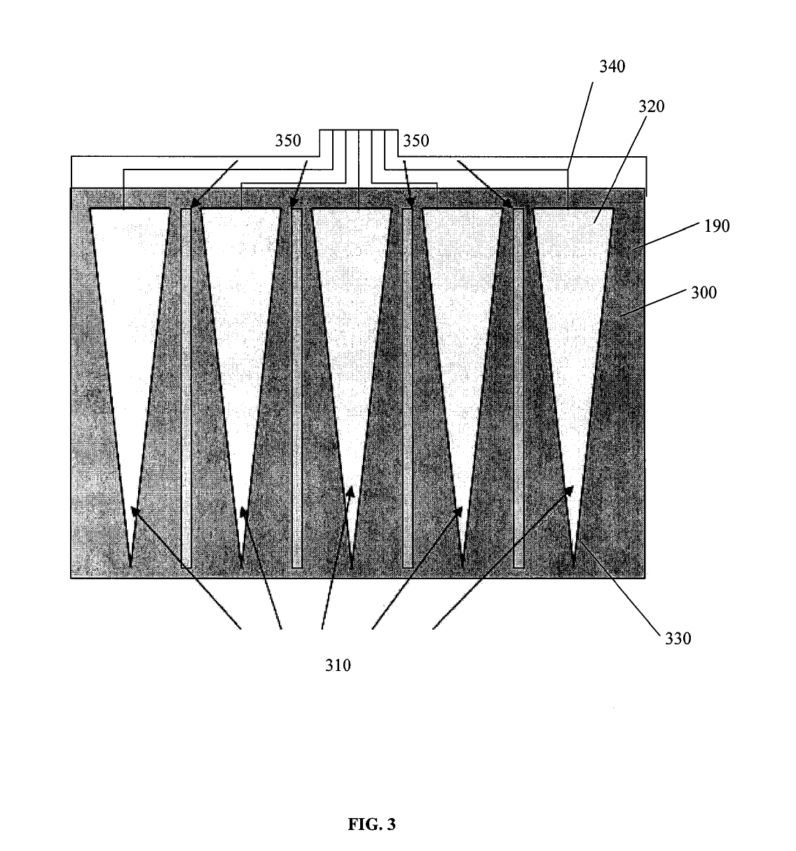

The display screen 150 of the device 100 has touchscreen capability provided by the touchscreen 140. The touchscreen 140 has a touch sensor (300 in FIG. 3) positioned over top of display screen 150 or integrated into the display screen 150. The display screen 150 and touch sensor 300 may be protected by a transparent cover or lens 190 positioned over the touch sensor 300 and display screen 150 or integrated into the display screen 150 or touch sensor 300.

Also shown on the display screen 150 as part of output 180 is a button or slidebar icon 160. The button or slidebar icon 160 may be touched by a user to generate an input through operation of the touchscreen 140. By touching the button or slidebar icon 160, for example, an input may be sent to the processor 230 to initiate an operation (e.g., sending a text message, etc.). The touchscreen 140 has associated circuitry and a controller or processor (e.g., 230, 240, 250) for determining where the user's touch was made on the sensor 300 and for sending the coordinates of the touch to the processor of the handheld electronic device 100 to determine a corresponding operation (e.g., the sending of the text message, etc.). In this way, the device 100 supports touchscreen functionality.

The memory 240 can be any of a variety of types of internal and/or external storage media such as, without limitation, RAM, ROM, EPROM(s), EEPROM(s), and the like that provide registers for data storage such as in the fashion of an internal storage area of a computer, and can be volatile memory or non-volatile memory. As shown in FIG. 2, the memory 240 is in electronic communication with the processor 230. The memory 240 additionally includes a number of modules 250 for the processing of data. The modules 250 can be in any of a variety of forms such as, without limitation, software, firmware, hardware, and the like. The one or more modules 250 may be executed or operated to perform methods of the present application as well as other functions that are utilized by the handheld electronic device 100. Additionally, the memory 240 can also store a variety of databases such as, without limitation, look-up tables, a language database, etc.

Thus, the handheld electronic device 100 includes computer executable programmed instructions for directing the device 100 to implement the embodiments of the present application. The programmed instructions may be embodied in one or more hardware or software modules 250 resident in the memory 240 or processing system 200 of the device 100. Alternatively, the programmed instructions may be embodied on a computer readable medium (such as a CD disk or floppy disk) which may be used for transporting the programmed instructions to the memory 240 of the device 100. Alternatively, the programmed instructions may be embedded in a computer-readable signal or signal-bearing medium that is uploaded to a network by a vendor or supplier of the programmed instructions, and this signal or signal-bearing medium may be downloaded through an interface (e.g., 210) to the device 100 from the network by end users or potential buyers.

FIG. 3 is a top view illustrating a touch sensor 300 and transparent cover 190 for the device 100 of FIG. 1. The touch sensor 300 includes at least one input pad (or button or slider) 310 formed in a layer of transparent conductive material (e.g., ITO, a conductive polymer, etc.) on a transparent substrate (e.g., a PET film, a glass, etc.). The input pad 310 tapers from a broad end 320 down to a narrow end 330. The taper of the input pad 310 provides a capacitance that varies with location of touch along the input pad 310. In particular, if a user touches the input pad 310 at its broad end 320, the impact on the electric field of the input pad 310 is larger and hence the touch has a larger effect on the capacitance of the input pad 310. In addition, if a user touches the input pad 310 at its narrow end 330, the impact on the electric field of the input pad 310 is smaller and hence the touch has a smaller effect of on the capacitance of the input pad 310. The capacitance of the input pad 310 when touched thus provides an indication of the location of the touch along the input pad 310.

The input pad 310 includes a contact 340 for coupling the input pad 310 to a controller or processor 230. The contact 340 may be located at the broad end 320 of the input pad 340 as shown in FIG. 3 or at the narrow end 330 of the input pad 310. Each contact 340 is routed via a trace (e.g., a silver trace, etc.) along the edge of the display screen 150 to a tail connector for coupling to the processor 230. The processor 230 receives a signal indicative of the capacitance from the input pad 310 and determines the location of touch from the capacitance. This may be performed by using a look-up table, for example. The processor 230 may include functionality similar to, for example, an AD7147 capacitance sensing integrated circuit (“IC”) available from Analog Devices™. This functionality may be included in the device's processor 230 or in a separate device coupled to the processor 230.

In FIG. 3, the input pads 310 have an isosceles triangle shape. However, the input pads 310 may have any tapered shape (e.g., right triangle shaped, etc.) having a broad end 320 and a narrow end 330. Also in FIG. 3, the input pads 310 are shown as being vertically arranged (i.e., broad end 320 up, narrow end 330 down). However, the input pads 310 may also be arranged horizontally (i.e., broad end 320 to the right or left, narrow end 330 to the left or right) or at any angle (e.g., broad end 320 down, narrow end 330 up). Furthermore, in FIG. 3, five input pads 310 are shown. However, the number of input pads 310 may vary depending on the application.

Also shown in more detail in FIG. 3 is the transparent cover or lens 190 for the touch sensor 300 and display screen 150. The lens 190 has ridges (or ribs) 350 formed thereon for guiding a user's finger between adjacent input pads 310. Each ridge 350 extends between the broad ends 320 and the narrow ends 330 of adjacent input pads 310. The ridges 350 may be formed on the transparent cover or lens 190 by injection moulding. The transparent cover or lens 190 may then be laminated to the sensor 300 using an optically clear adhesive.

When touched, the capacitance of the input pad 310 provides an indication of the location of the touch along the input pad 310. As such, the input pad 310 may be used to initiate multiple operations via multiple icons 160 displayed over the input pad 310 on the display screen 150. Recall, of course, that the input pad 310 is transparent when formed on a transparent substrate.

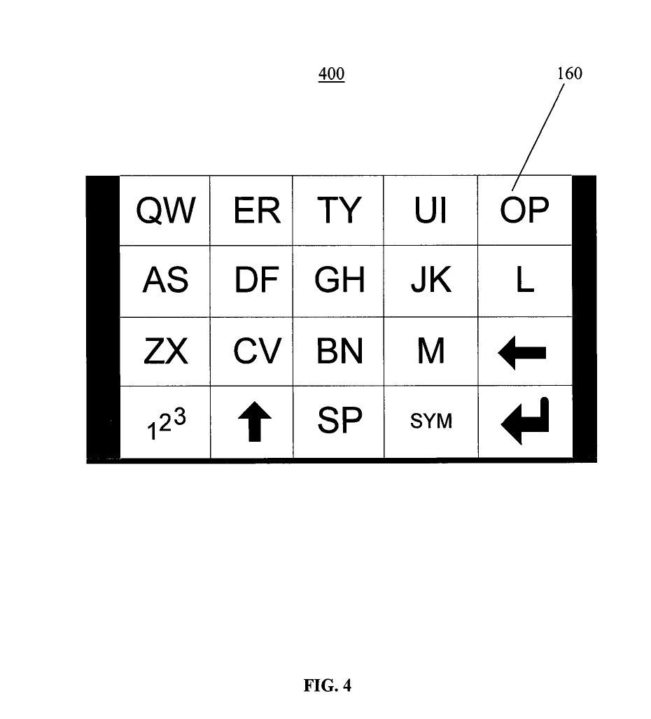

FIG. 4 is a screen capture illustrating a keypad 400 presented on the display screen 150 of FIG. 1. In FIG. 4, various icons 160 are presented in rows and columns. Each column of icons (e.g., TY, GH, BN, SP) is associated with a single input pad 310. Because the capacitance of the input pad 310 varies from top 320 to bottom 330, detection of which icon 160 a user has selected is possible by associating the capacitance value of the touch with a location along the input pad 310 and hence to a position of a selected icon 160 on the display screen 150.

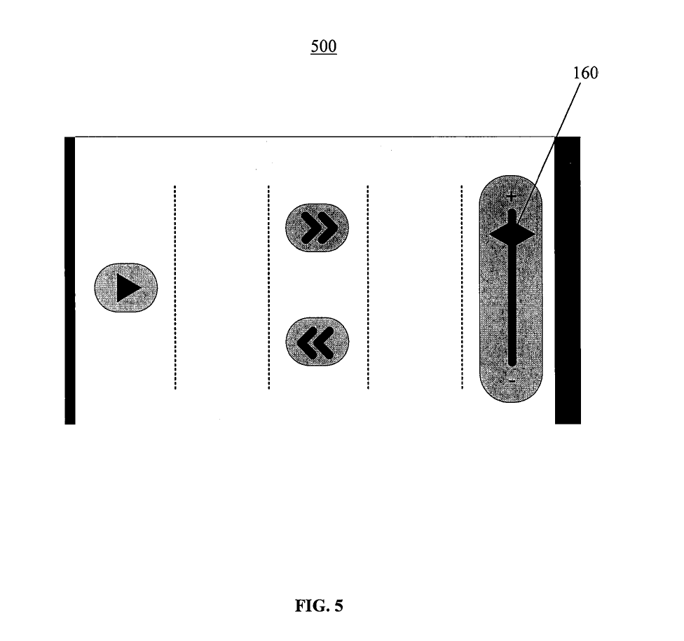

FIG. 5 is a screen capture illustrating a multimedia controller 500 presented on the display screen 150 of FIG. 1. In FIG. 5, various icons 160 are presented in rows and columns. Each column of icons is associated with a single input pad 310. Again, because the capacitance of the input pad 310 varies from top 320 to bottom 330, detection of which icon 160 a user has selected is possible by associating the capacitance value of the touch with a location along the input pad 310 and hence to a position of a selected icon 160 on the display screen 150. The single input pad 310 is particularly useful for implementing slide bar operations through a slide bar icon 160 (e.g., a volume control slide bar). Because the capacitance varies from top 320 to bottom 330 along the input pad 310 when it is touched, a smooth slide bar operation may be readily implemented.

The rows and columns of icons 160 shown in FIGS. 4 and 5 may be considered to be a X/Y matrix. The X position in the matrix is determined by which input pad 310 is touched while the Y position in the matrix is determined by where along the input pad 310 the touch is made.

The columns of icons 160 shown in FIGS. 4 and 5 are aligned with the ridges 350 shown in FIG. 3. The ridges (or ribs) 350 guide the user's finger to appropriate touch locations. A ridge 350 is located between each input pad 310. The use of the ridges 350 helps to prevent multiple touches on an input pad 310. In the operation of a typical handheld device 100, a user uses his or her left-hand and right-hand thumbs to press keys on the keypad 120 of the device 100. Similarly, a user would use his or her left-hand and right-hand thumbs to select icons 160 presented on the display screen 150 of the device 100. In this scenario, the use of vertical ridges 350 reduces the chance that a user will select multiple icons 160 in adjacent columns by activating adjacent input pads 310. Of course, rather than using his or her left-hand and right-hand thumbs, a user may also use his or her fingers (e.g., index finger, forefinger, etc.).

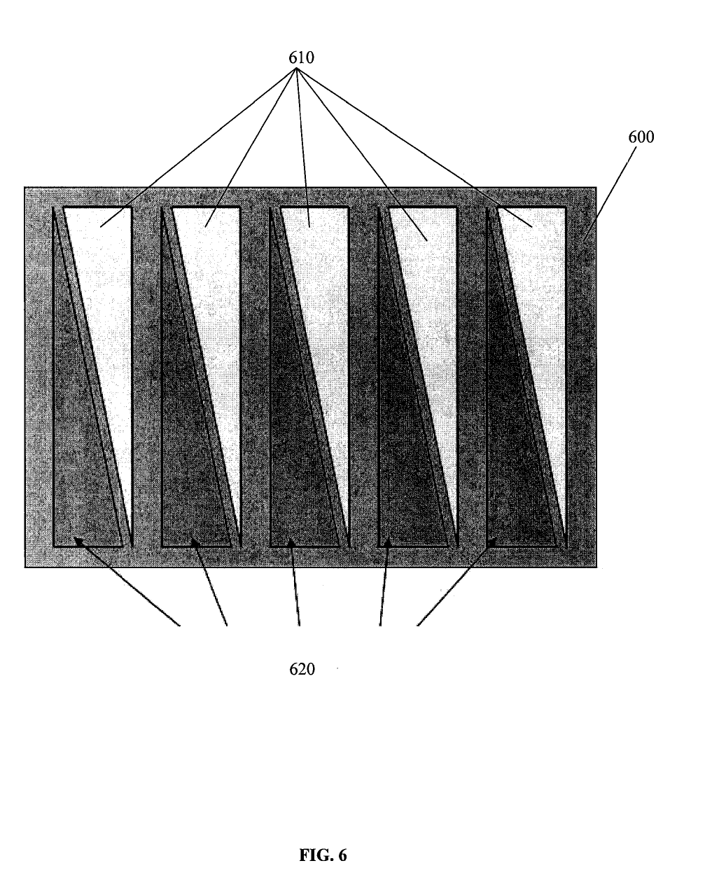

FIG. 6 is a top view illustrating an alternate touch sensor 600 for the device 100 of FIG. 1. In FIG. 6, each input pad 610 has an adjacent correspondingly shaped, but oppositely oriented, reference pad 620. As such, the capacitance of the reference pad 620 will vary inversely to that of the input pad 610 when both pads 610, 620 are touched at the same location. In FIG. 6, each input pad 610 is right triangle shaped with its broad end towards the top of the sensor 600. As such, each reference pad 620 is also right triangle shaped but has its broad end towards the bottom of the sensor 600. By orientating a pair of input and reference pads 610, 620 in this way, the likelihood that both of the input and reference pads 610, 620 in a pair are touched simultaneously, is increased. The input pads 610 and reference pads 620 are formed on the same substrate. That is, only one layer of transparent conductive material is required. The reference pads 620 allow for a reduction in noise effects and for improved touch input differentiation between adjacent input pads 610. With the sensor 600 of FIG. 6, the location of touch along an input pad 610 (i.e., the Y position in the X/Y matrix referred to above) may be determined by the ratio of the capacitance of the input pad 610 to that of its corresponding reference pad 620 when both are touched. By using this ratio rather than an absolute capacitance value, noise effects and the need for calibration may be reduced making the sensor 600 more tolerant to manufacturing variations.

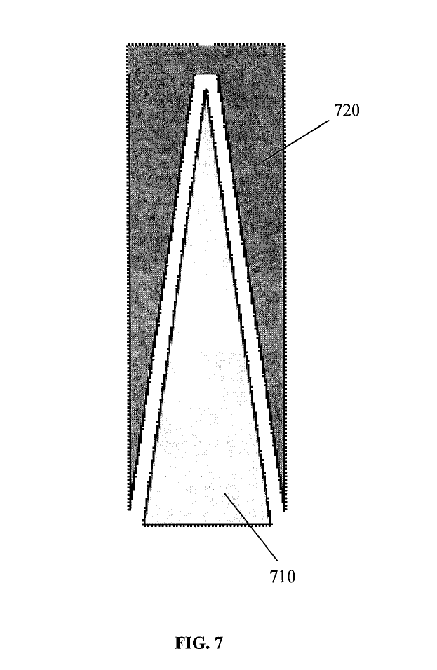

FIG. 7 is a top view illustrating an alternate input and reference pads 710, 720 for the device 100 of FIG. 1. In FIG. 7, the input pad 710 is isosceles triangle shaped as in FIG. 4 and the reference pad 720 is in the form of a pair of joined right triangle shaped sections that are shaped to receive the input pad 710. Of course, an input pad 710 and its corresponding reference pad 720 may have any complementary shapes that support the use of a ratio of capacitance to determine location of touch along the input pad 710.

The above embodiments may provide one or more advantages. First, the ridges or ribs 350 formed on the transparent cover or lens 190 of the display screen 150 provide a useful guide for a user's fingers. Second, the tapered input pads 310 allow for the implementation of an X/Y matrix of icons 160 without the use of multiple layers of transparent conductive material. Third, the use of tapered input pads 310 reduces the number of input channels required for a processor 230 implementing an X/Y matrix. For example, only five input channels are required to implement the 5×4 matrix of FIG. 4 while a previous two layer solution would require nine input channels. Fourth, by reducing the number of transparent conductive material layers, the optical performance of the display screen 150 is improved while production costs are reduced. Fifth, a decreased number of processor input channels allows for faster channel scanning.

The embodiments of the application described above are intended to be exemplary only. Those skilled in this art will understand that various modifications of detail may be made to these embodiments, all of which come within the scope of the application.

What is claimed is:

1. A touch sensor for mounting over a display screen of an electronic device, comprising:
an elongate input pad formed in a layer of transparent conductive material on a transparent substrate, the input pad tapering from a broad end to a narrow end to provide an input pad capacitance that varies with location of a touch over the input pad; and,
a contact for coupling the input pad to a processor.

2. The touch sensor of claim 1 and further comprising a transparent cover mounted over the touch sensor for receiving the touch from an implement, the transparent cover having formed thereon one or more elongate ridges for guiding the implement over the input pad between the broad and narrow ends.

3. The touch sensor of claim 2 and further comprising an elongate reference pad formed adjacent to the input pad in the layer of transparent conductive material, the reference pad tapering oppositely to that of the input pad to provide a reference pad capacitance that varies with the location of the touch over the reference pad inversely to that of the input pad capacitance.

4. The touch sensor of claim 1 wherein the processor is adapted to receive a signal indicative of the input pad capacitance and to determine the location of the touch from the input pad capacitance.

5. The touch sensor of claim 3 wherein the processor is adapted to receive signals indicative of the input and reference pad capacitances and to determine the location of the touch from a ratio of the input pad capacitance and the reference pad capacitance.

6. The touch sensor of claim 2 wherein the implement is a user's finger.

7. The touch sensor of claim 2 wherein the input pad and the one or more ridges are essentially vertical.

8. The touch sensor of claim 7 wherein the electronic device is a handheld electronic device and the implement is a user's thumb.

9. The touch sensor of claim 3 wherein the display screen is a liquid crystal display (“LCD”) screen.

10. The touch sensor of claim 9 wherein the transparent conductive material is indium tin oxide (“ITO”).

11. The touch sensor of claim 9 wherein the transparent conductive material is a conductive polymer.

12. The touch sensor of claim 9 wherein the transparent substrate is a polyethylene terephthalate (“PET”) polyester film.

13. The touch sensor of claim 9 wherein the transparent substrate is a glass.

14. The touch sensor of claim 1 wherein the input pad has an isosceles triangle shape.

15. The touch sensor of claim 3 wherein the input and reference pads have opposing right triangle shapes.

16. The touch sensor of claim 3 wherein the reference pad is shaped to receive the narrow end of the input pad.

17. The touch sensor of claim 3 wherein the reference pad capacitance is complementary to the input pad capacitance.

18. The touch sensor of claim 1 wherein the input pad is a plurality of input pads arranged as a keypad, wherein each of the plurality of input pads forms a respective column of the keypad, wherein each of the plurality of input pads has a respective plurality of touch locations, wherein each of the plurality of touch locations corresponds to a respective key in the respective column of the keypad, and wherein each of the plurality of input pads has a respective contact for coupling to the processor, whereby the plurality of input pads provides multi-touch functionality across different columns of the keypad.

19. The touch sensor of claim 1 wherein the input pad forms a column of a keypad, wherein the input pad has a plurality of touch locations, wherein each of the plurality of touch locations provides a respective input pad capacitance when touched, and wherein each of the plurality of touch locations corresponds to a respective key in the column of the keypad, whereby the input pad provides multi-touch functionality for the column of the keypad.

20. A touch sensor keypad for mounting over a display screen of an electronic device, comprising:
at least one elongate input pad formed in a layer of transparent conductive material on a transparent substrate, the input pad tapering from a broad end to a narrow end to provide a respective input pad capacitance for each of a plurality of locations of a touch over the input pad; and,
a contact for coupling the input pad to a processor;
wherein the input pad forms a column or row of the keypad; and,
wherein each of the plurality of locations of the touch corresponds to a respective key in the column or row of the keypad;
whereby the input pad provides multi-touch functionality for the column or row of the keypad.
